(19) United States
(12) Patent Application Publication
(10) Pub. No.: US 2026/0066199 A1
(43) Pub. Date: Mar. 5, 2026

(54) ARC-EXTINGUISHING APPARATUS

(71) Applicant: Yixuan ZHANG, Changzhou (CN)

(72) Inventors: Yixuan ZHANG, Changzhou (CN); Qiaoshi GUO, Guangzhou (CN)

(21) Appl. No.: 19/385,123

(22) Filed: Nov. 10, 2025

Related U.S. Application Data
(63) Continuation of application No. PCT/CN2024/102274, filed on Jun. 28, 2024.

(30) Foreign Application Priority Data
Jun. 29, 2023 (CN) 2023107839257
Jul. 28, 2023 (CN) 2023109418981
Jun. 28, 2024 (CN) 2024108533258

(51) Int. Cl. H01H 33/14

(52) U.S. Cl. CPC H01H 33/14; H01H 2033/146

(57) ABSTRACT

An arc-extinguishing apparatus includes a first device, main loop electrodes of the first device include a first electrode and a second electrode; and a switch, which needs to be subjected to arc extinguishing and includes a first end, a second end and a contact bridge, the first electrode and the second electrode are respectively configured to connect to the first end and the second end. The apparatus further includes a capacitor and a first voltage detection switch, the first voltage detection switch and a third electrode and the second electrode of the first device constitute a first series circuit, the contact bridge and the second end constitute a second series circuit, the first series circuit is connected in parallel to the second series circuit, and the capacitor is connected in parallel to the second series circuit.

### CROSS-REFERENCE TO RELATED APPLICATIONS

This application is a national stage entry of International Patent Application No. PCT/CN2024/102274, filed on Jun. 28, 2024, and claims priority of Chinese Patent Application No. 2023107839257, filed on Jun. 29, 2023, Chinese Patent Application No. 2023109418981, filed on Jul. 28, 2023, and Chinese Patent Application No. 2024108533258, filed on Jun. 28, 2024, all of which are incorporated herein by reference in their entireties.

### TECHNICAL FIELD

The present disclosure relates to an arc-extinguishing apparatus, and in particular to an arc-extinguishing apparatus suitable for the arc extinguishing of a switch of a bridging (connection) structure with high cost-effectiveness, simple circuitry, good arc-extinguishing performance and high reliability.

### BACKGROUND ART

DC scenarios are increasingly common. However, DC arc extinguishing has been a challenge.

### SUMMARY

The object of the present disclosure is to solve the problems described in the background art and to provide an arc-extinguishing apparatus which has the advantages of high cost-effectiveness, simple circuitry, good arc-extinguishing performance, high reliability, and is suitable for a bridging structure switch.

The object of the present disclosure is achieved by the following technical solutions:

As shown in FIG. 1, an arc-extinguishing apparatus includes a first device QA. The main loop electrodes of the first device QA include a first electrode 1 and a second electrode 2. The switch S1 to be arc-extinguished includes a first end N1 (that is, the node where the first static contact of the switch S1 is located), a second end N2 (that is, the node where the second static contact of the switch S1 is located), and a contact bridge N3. The first electrode 1 and the second electrode 2 are respectively configured to connect to the first end N1 and the second end N2. The apparatus also includes a capacitor C1 and a first voltage detection switch VT1. The first voltage detection switch VT1, the third electrode 3 of the first device QA, and the second electrode 2 form a first series circuit. The contact bridge N3 and the second end N2 form a second series circuit. The first series circuit is connected in parallel with the second series circuit, and the capacitor C1 is connected in parallel with the second series circuit.

Working principle: As shown in FIG. 1, when the contact bridge N3 is disconnected from the second end N2, the potential difference between the contact bridge N3 and the second end N2 quickly charges the capacitor C1 (which can also realize arc extinguishing for the second series circuit). When the voltage of the capacitor C1 (the second series circuit) (the voltage between the contact bridge and the third electrode) reaches the turn-on voltage of the first voltage detection switch VT1, the first voltage detection switch VT1 is turned on, and the voltage of the capacitor C1 drives the first device QA to be turned on, thereby realizing arc extinguishing between the first end N1 and the second end N2. Then, the capacitor C1 cannot obtain a continuous charging power source, and the first device QA is turned off to complete the working process.

The present disclosure has the advantages of rational design, high cost-effectiveness, simple circuitry, good arc-extinguishing performance and high reliability.

### BRIEF DESCRIPTION OF DRAWINGS

FIG. 1 is a schematic diagram of the arc-extinguishing apparatus of the present disclosure.

FIG. 2 is a schematic diagram of an embodiment of the arc-extinguishing apparatus of the present disclosure.

FIG. 3 is a schematic diagram of the first voltage detection switch of the arc-extinguishing apparatus of the present disclosure.

FIG. 4 is a schematic diagram of the second voltage detection switch of the arc-extinguishing apparatus of the present disclosure.

FIG. 5 is a schematic diagram of the turn-on waveforms of the first detection switch and the second voltage detection switch of the arc-extinguishing apparatus of the present disclosure.

FIG. 6 is a schematic diagram of the switch to be arc-extinguished of the arc-extinguishing apparatus of the present disclosure.

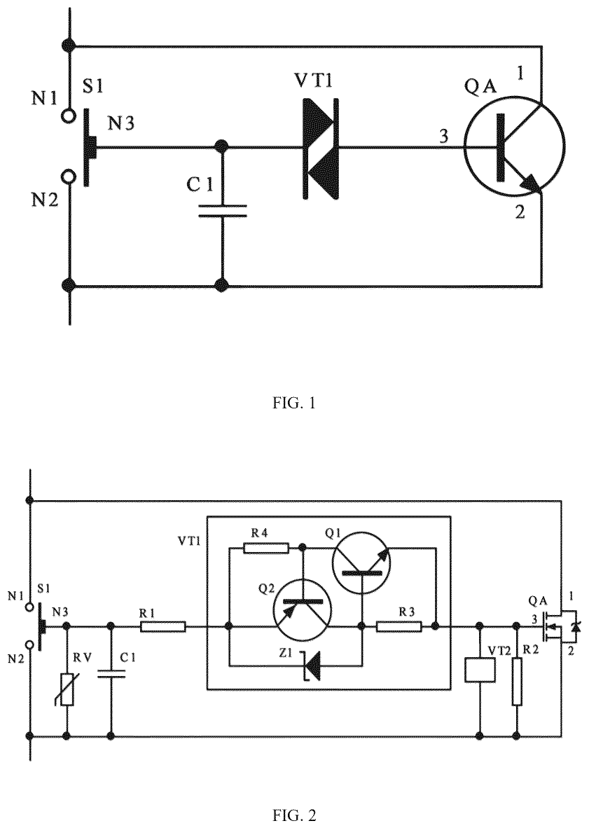

### DESCRIPTION OF EMBODIMENTS

Embodiment of the present disclosure:

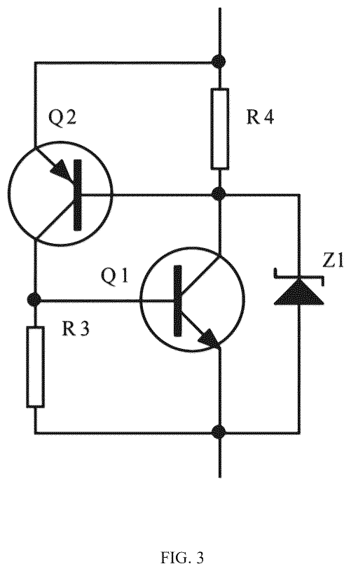

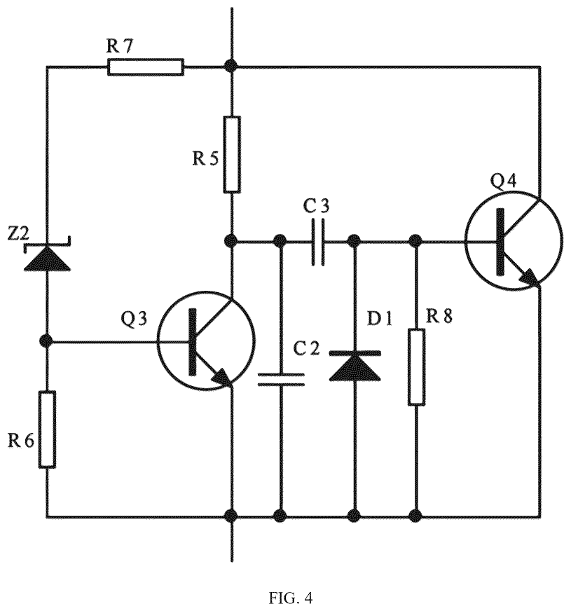

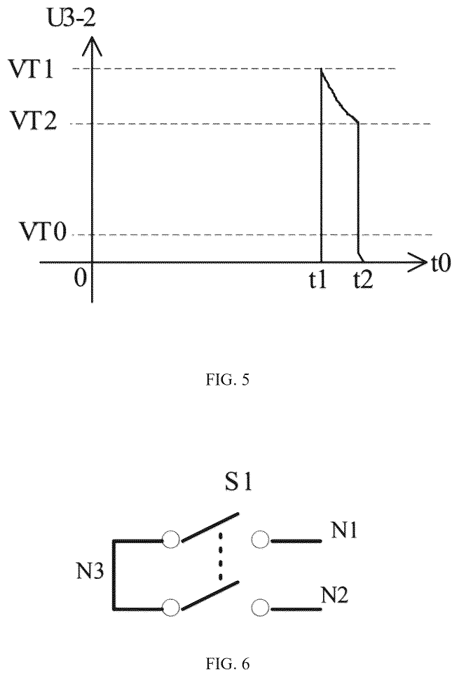

As shown in FIG. 2, an arc-extinguishing apparatus includes a first device QA (a fully controlled device, preferably a field-effect transistor or an IGBT). The main loop electrodes of the first device QA include a first electrode 1 (drain, or collector) and a second electrode 2 (source, or emitter), a capacitor C1, a first resistor R1, a second resistor R2, a first voltage detection switch VT1, a second voltage detection switch VT2, and a voltage-limiting device RV (Zener device). The switch S1 to be arc-extinguished includes a first end N1, a second end N2, and a contact bridge N3. The first electrode 1 and the second electrode 2 are respectively configured to connect to the first end N1 and the second end N2. The switch S1 is a bridging structure (two single-break switches can be connected in series to form a bridging structure switch). The first resistor R1, the first voltage detection switch VT1, the third electrode 3 (gate) of the first device QA, and the second electrode 2 form a first series circuit. The contact bridge N3 and the second end N2 form a second series circuit. The first series circuit is connected in parallel with the second series circuit, and the capacitor C1 and the voltage-limiting device RV are connected in parallel with the second series circuit; the first voltage detection switch VT1 is configured to detect the voltage of the capacitor (the second series circuit, between the third electrode and the capacitor C1 or the contact bridge N3). The first voltage detection switch VT1 is configured to turn on when the voltage of the capacitor C1 is greater than the voltage required to drive the first device QA to be saturated and conducted; the second voltage detection switch VT2 (as shown in FIG. 4, composed of a resistor, a capacitor, a transistor, a diode, and a Zener device or other similar circuits can be used) is connected to the first series circuit. The second voltage detection switch VT2 is configured to turn on when the detected voltage is less than the designed value of the second voltage detection switch VT2, to discharge the capacitor C1. The turn-on voltage of the second voltage detection switch VT2 is less than the turn-on voltage of the first voltage detection switch VT1 (as shown in FIG. 5, which is a schematic diagram of the driving voltage waveform between the third electrode and the second electrode); the second voltage detection switch VT2 is a time-delay switch; the turn-on voltage of the first voltage detection switch VT1 is greater than the voltage required to drive the first device QA to be saturated and conducted; the second electrode 2, the third electrode 3 and the second resistor R2 are connected in parallel.

The first voltage detection switch VT1 is a semi-controlled switch (trigger switch), which is composed of a first voltage-stabilizing device Z1 (used for adjusting the turn-on voltage) and a semi-controlled semiconductor switch (preferably a thyristor equivalent circuit composed of transistors, which can be replaced by a thyristor). The semi-controlled semiconductor switch includes a first transistor Q1 (N-type) and a second transistor Q2 (P-type). The base of the first transistor Q1 is connected to the collector of the second transistor Q2. The base of the second transistor Q2 is connected to the collector of the first transistor Q1. The two ends of the first voltage-stabilizing device Z1 are respectively connected to the emitter and collector of the first transistor Q1 (as shown in FIG. 3), or the two ends of the first voltage-stabilizing device Z1 are respectively connected to the emitter and collector of the second transistor Q2 (as shown in FIG. 2). The third resistor R3 and the fourth resistor R4 respectively connected to the transistors Q1 and Q2 are configured to improve the stability of the circuit; the first voltage detection switch VT1 can also be a trigger diode (and its equivalent electrical characteristic device, also defined as a semi-controlled switch), or other equivalent circuits.

Working principle: When the contact bridge N3 is disconnected from N2, the contact bridge N3 quickly charges the capacitor C1 to extinguish the arc of the second series circuit (that is, to extinguish the arc between N3 and N2). When the voltage of the capacitor C1 reaches the turn-on voltage of the first voltage detection switch VT1, the first voltage detection switch VT1 is turned on, and the voltage of the capacitor C1 drives the first device QA to be saturated and conducted, thereby realizing arc extinguishing between the first end N1 and the second end N2. The first voltage detection switch VT1 is configured to turn on when the voltage of the capacitor C1 reaches the voltage required to drive the first device QA to be saturated and conducted; the second voltage detection switch VT2 is configured to turn on when the detected voltage provided by the capacitor C1 is less than the designed value of the second voltage detection switch VT2, thereby realizing the rapid turn-off of the first device QA.

The switch to be arc-extinguished can be a switch with a bridging structure formed by connecting two single-break switches (as shown in FIG. 6). The common node of the two single-break switches is also defined as a contact bridge.

The above embodiment can also be provided with a diode, and the contact bridge N3 charges the capacitor C1 through the diode.

In the above embodiment, the voltage-limiting device RV can be a varistor, or a Zener diode, or a transient suppression diode, and related equivalent devices; the withstand voltage value (turn-on voltage) of the voltage-limiting device RV can be selected to be less than the system working voltage of the switch (for example, for a system working voltage of hundreds of volts, a voltage-limiting device with a turn-on voltage of 10 to 35 volts can be directly selected. The withstand voltage value of the voltage-limiting device RV is preferably less than the withstand voltage value between the third electrode and the second electrode). The withstand voltage values of the matching capacitor C1 and the first voltage detection switch VT1 can be selected to be less than the system working voltage of the switch S1, which is conducive to greatly reducing the cost and volume of the arc-extinguishing apparatus of the present disclosure.

In the above embodiment, as shown in FIG. 5, the values of VT1 and VT2 can be adjusted by Z1 and Z2. The pulse width of the pulse voltage driving QA can be flexibly adjusted by the relevant parameters of Z1, Z2, RI, R2, C1, and RV, which has the advantage of stable pulse signal.

In the above embodiment, when the first voltage detection switch adopts a voltage-controlled device (field-effect transistor, IGBT) to drive the IC, it integrates the second voltage detection switch (function), which has the advantage of smaller volume.

The present disclosure utilizes the rapid charging of the capacitor C1 to realize arc extinguishing between N3 and N2, or to reduce the arc. The potential difference between N3 and N2 rises rapidly, which can further accelerate the charging speed of the capacitor. When the first voltage detection switch detects that the capacitor voltage meets the condition for driving the first device QA to be saturated and conducted, it drives the first device QA to be rapidly saturated and conducted. By utilizing the characteristic that the first voltage detection switch is a semi-controlled switch, the signal pulse width for driving the first device QA is met, and the circuit is prevented from oscillating, thereby reducing the risk of damage to the arc-extinguishing apparatus.

The present disclosure has the advantages of rational design, high cost performance, simple circuitry, good arc-extinguishing effect and high reliability.

What is claimed is:

1. An arc-extinguishing apparatus, comprising:
a first device (QA), wherein main loop electrodes of the first device (QA) comprise a first electrode (1) and a second electrode (2), a switch (S1) to be arc-extinguished comprises a first end (N1), a second end (N2) and a contact bridge (N3), the first electrode (1) and the second electrode (2) are respectively configured to connect to the first end (N1) and the second end (N2);
a capacitor (C1); and
a first voltage detection switch (VT1), wherein the first voltage detection switch (VT1), a third electrode (3) of the first device (QA) and the second electrode (2) form a first series circuit, the contact bridge (N3) and the second end (N2) form a second series circuit, the first series circuit is connected in parallel with the second series circuit, and the capacitor (C1) is connected in parallel with the second series circuit.

2. The arc-extinguishing apparatus according to claim 1, wherein the first voltage detection switch (VT1) is configured to detect the voltage of the capacitor (C1) or the second series circuit, and the first voltage detection switch (VT1) is configured to turn on when the voltage of the capacitor (C1) is greater than the voltage required to drive the first device (QA) to be saturated and conducted.

3. The arc-extinguishing apparatus according to claim 1, wherein the apparatus further comprises a second voltage detection switch (VT2) connected to the first series circuit, the second voltage detection switch (VT2) is configured to turn on when the detected voltage is less than a designed value of the second voltage detection switch (VT2), to discharge the capacitor (C1), and a turn-on voltage of the second voltage detection switch (VT2) is less than a turn-on voltage of the first voltage detection switch (VT1).

4. The arc-extinguishing apparatus according to claim 3, wherein the second voltage detection switch (VT2) is a time-delay switch.

5. The arc-extinguishing apparatus according to claim 1, wherein the apparatus further comprises a diode, and the contact bridge (N3) charges the capacitor (C1) through the diode.

6. The arc-extinguishing apparatus according to claim 1, wherein the first voltage detection switch (VT1) is a voltage-controlled device driving IC.

7. The arc-extinguishing apparatus according to claim 1, wherein the apparatus further comprises a voltage-limiting device (RV), and the voltage-limiting device (RV) is connected in parallel with the second series circuit.

8. The arc-extinguishing apparatus according to claim 7, wherein a withstand voltage value of the voltage-limiting device (RV) is less than a system working voltage of the switch (S1).

9. The arc-extinguishing apparatus according to claim 7, wherein a withstand voltage value of the capacitor (C1) is less than a system working voltage of the switch (S1).

10. The arc-extinguishing apparatus according to claim 7, wherein a withstand voltage value of the first voltage detection switch (VT1) is less than a system working voltage of the switch (S1).
